(19) United States
(12) Patent Application Publication
(10) Pub. No.: US 2023/0125104 A1
(43) Pub. Date: Apr. 27, 2023

(54) Digital N.L.I. Moderation

(71) Applicant: Mohamed Azeez, Long Island City, NY (US)

(72) Inventor: Mohamed Azeez, Long Island City, NY (US)

(21) Appl. No.: 17/971,621

(22) Filed: Oct. 23, 2022

Related U.S. Application Data
(60) Provisional application No. 63/264,189, filed on Nov. 17, 2021.
(60) Provisional application No. 63/271,607, filed on Oct. 25, 2021.

(51) Int. Cl. G06F 16/9536; G06F 40/205; G06V 10/764

(52) U.S. Cl. CPC G06F 16/9536; G06F 40/205; G06V 10/764

(57) ABSTRACT

A method for moderating a group or network members name, likeness, or image (NLI), said method comprising the steps of: receiving a request to publish digital content by any member of a group or wider network featuring any NLI of at least one other member (viewing member) aside from the publishing member; detecting any objects within the featured content, wherein each content is assigned an NLI value, wherein the NLI values are based on probability of association with any one of the viewing members; and notifying the at least one viewing member associated with the detected object with a threshold NLI value (NLI affected) of the request to publish and requiring consent to publish from the NLI affected viewing member.

### FIELD OF INVENTION

The invention pertains generally to the field of electronic communication, and more particularly to a group control architecture/scheme for sharing digital content over a network.

### BACKGROUND OF INVENTION

Despite the growing advancements in digital privacy and controls, there remains significant blind spots. One significant blind spot is the sharing of digital content within a private group that includes a name, likeness, or image (NLI) of oneself without the express approval of that oneself. There are a countless number of occasions when any one individual of a private group may share photographs or video depicting another individual within the group in a not so flattering way. What's worse, content initially shared within the group may be published to the wider public having consequences beyond just simply being embarrassed—reputation threatening, for instance. There is a need for members of a group—and/or moderator of a site—to affirmatively consent to NLI content prior to digital publication (Digital NLI Moderation). Affirmative consent should be based on an arbitrary, group-defined, or score-defined guideline. Moreover, with the ubiquity of avatars as visual representation of users in digital environments, there is a need to demand visually accurate avatars that reflect real-time digital engagement with physically impactful activities. For instance, if a user has not exercised as usual in a first virtual environment, but rather, snacked more than usual in a second virtual environment, there should be a corresponding change to the avatar to reflect this tracked virtual behavior. With the metaverse and other immersive experiences that blur the virtual and physical worlds on the horizon, dynamically modifying an avatar to accurately reflect a user in his or her physical environment may be useful in determining avatar accuracy. Suppose the user has not been reaching his step goals in the physical world, this may visually impact the avatar that has already been virtually-tracked/impacted. NLI scores are needed to quantitatively assess visual accuracy for moderators/gate-keepers to rely on to grant/deny permission into a virtual/physical environments. NLI scores may be assessed each for a physically tracked footprint and virtually tracked footprint, or aggregated to account for the users global footprint. Without visually representative avatars, we are cross-engaging between these worlds in the blind

### SUMMARY

The invention resides in enabling a first user to provide consent in order for the second user to share the digital content featuring the first user—across a group, social network, or public domain.

It is one object of the present disclosure to provide a platform/portal for digital content sharing across a private group or network—enabling each user of the group to have administrative control to consent to or veto publishing content featuring the user. Content uploaded for publication may initially be flagged for detecting NLI for a single person or multiple people of the group/network. Detection may be based on standard computer vision/machine learning techniques for object/instance segmentation. Detected NLI may then prompt pushing an NLI notification to a device associated with each user detected in the content. Each detected user may then have an option to view the content at issue and determine whether to consent or reject the content-based on each detected users arbitrary standard or a group-defined standard; eventual publication—and eventually publish any publication constraints—dictated by the detected user. It may even be possible, in a certain embodiment, for mob-rule to dictate: consenting, rejecting, or overruling a users' dictates with a majority or consensus vote to publish despite the users' rejection of the content.

It is another object for a moderator of a site to decide to publish avatar-based NLI content based on a quantitative measure of NLI accuracy (NLI score). The NLI score may be a reflection of how closely aligned the visual elements of the avatar are with the avatars virtual/physical experiences/consumptions (avatar footprint). With concepts such as the metaverse and other immersive virtual environments (m/v) on the horizon, avatars will be the predominant point of contact, representing a user in the m/v. Avatars that are more fluid and dynamic, evolving in real-time to reflect the full gamut of digital experiences of the user, will be expected from all those engaged in the environment. Tracking a digital footprint of a user, determining a physical attribute impact, and visualizing the determined impact on the users avatar. In other embodiments, the level of correspondence between the determined impact and visualized impact renders a score to quantitatively assess visual accuracy based on the tracked footprint. The NLI score may serve a gatekeeping function by being relied on by site moderators or any user in a group/network setting to grant/deny permission for the user to engage; a low NLI score indicating an avatar that is visually inaccurate or misrepresentative—suggesting a lack of digital honesty and worthiness to engage in the environment. Conversely, a high score indicating a worthiness to engage.

It is yet another object to decentralize administrative control and distribute control over content sharing across any one of the plurality of users within a group. By distributing control across a group or among users featured in a received image or video—rather than just the group creator—featured users can now better shape their digital NLI.

### BRIEF DESCRIPTION OF FIGURES

FIG. 1A depicts a system diagram in accordance with an aspect of the invention.

FIG. 1B depicts a system diagram in accordance with an aspect of the invention.

FIG. 2 depicts a method flow diagram in accordance with an aspect of the invention.

FIG. 3 depicts a method flow diagram in accordance with an aspect of the invention.

FIG. 4 depicts a method flow diagram in accordance with an aspect of the invention.

### DETAILED DESCRIPTION

Numerous embodiments of the invention will now be described in detail with reference to the accompanying figures. The following description of the embodiments of the invention is not intended to limit the invention to these embodiments but rather to enable a person skilled in the art to make and use this invention. Variations, configurations, implementations, and applications described herein are optional and not exclusive to the variations, configurations, implementations, and applications they describe. The invention described herein can include any and all permutations of these variations, configurations, implementations, and applications.

In the following description, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

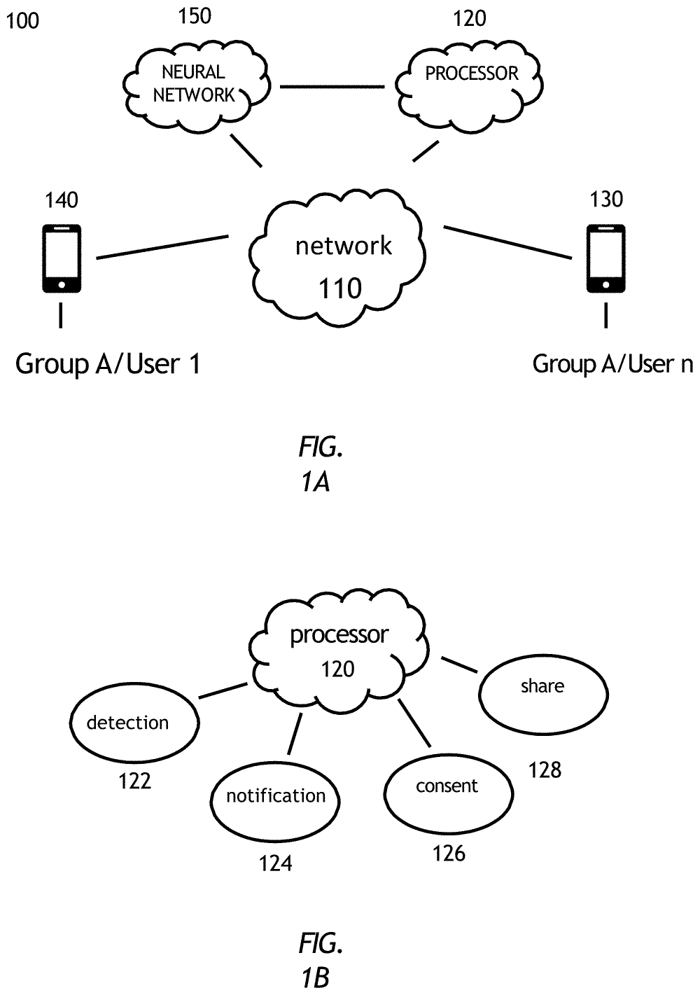

FIG. 1A and FIG. 1B depict a system diagram in accordance with an aspect of the invention. FIG. 1A depicts a schematic of a system 100 (Group-Aware Digital Sharing or GADS) for capturing (optional), receiving, detecting, notifying, consenting, and sharing consent-required digital content across a group or social network. In one embodiment, a system 100 can include: a network 110, a processor 120, and an electronic computing device, such as a user 1 device 130 (mobile device group A/user 1, etc.), and a user n device 140 (mobile device group A/user n). The processor 120 (optionally, a neural network 150) and the devices 130, 140 are communicatively coupled via a communication network 110. The network may be any class of wired or wireless network including any software, hardware, or computer applications that can provide a medium to exchange signals or data. The network may be a local, regional, or global communication network.

The devices 130, 140 may be any electronic device capable of sending, receiving, and processing information. Examples of the computing device include, but are not limited to, a smartphone, a mobile device/phone, a Personal Digital Assistant (PDA), a computer, a workstation, a notebook, a mainframe computer, a laptop, a tablet, a smart watch, airport tablet station, aircraft infotainment system, an internet appliance and any equivalent device capable of processing, sending and receiving data. The devices 130, 140 can include any number of sensors or components configured to intake or gather data/images/video from a user of the device 130, 140 including, but not limited to, a camera, a heart rate monitor, a temperature sensor, an accelerometer, a microphone, and a gyroscope. The device 130, 140 can also include an input device (e.g., a touchscreen or a keyboard) through which a user may input text and commands by cursor point control or touch/gesture.

FIG. 1B further details components that comprise the group-aware digital content sharing engine: a detection module 122; a notification module 124; a consent module 126; and a sharing module 128. The processor 120 (on or off-board) may optionally communicate with a neural network (FIG. 1A, 150) to publish/share images or video within a group or via social media that are fully/threshold-grade consented to by the group or consented to by any number of the users detected/recognized in the image or video. In one embodiment, a system for group-aware digital content sharing further comprises the use of a deep neural network or convolutional neural network for detecting/recognizing registered users of the group from the captured/received image for notification/consent request from the detected/recognized users.

While not shown in FIG. 1B, the processor may further include a camera controller module, an interface/thumbnail gallery module, a graphic/visual imposition gallery module, a sharing/media module and a library of footage/frames from any one of the cameras. In this embodiment, after receiving a touch command for conditionally sharing a particular image/video presented in thumbnail gallery fashion, user 1 may be alerted of its consent pending status, while the detected/recognized user 2 may be notified with a consent request. Once user 2 consents to the sharing of the image, the consent pending status is lifted and the image/video in question is shared among the plurality of users within the group or shared among user 1 or user 2's social media network. In the event that user 2 does not consent,

In one scenario, while on vacation together in Hawaii, one of the four registered users (user 1) decided to share an image of user 1 and user 3 posing near a dolphin while on a dolphin excursion. Once being alerted of the pending status of the image featuring user 3, user 3 may click quick consent, view the image for consent, or pre-set auto-consent. User 3 isn't pleased with the fact that the image is depicting user 3 as a weak swimmer and afraid of the dolphin. As a result, user 3 elects to not provide consent for the sharing of the image. User 1 is then notified of the lack of consent and the image or video is flagged as not shareable. In other embodiments, user 1 may be prevented from downloading/uploading the flagged image/video onto any device, remote storage, application, web browser, and/or prevented from being screen-shot.

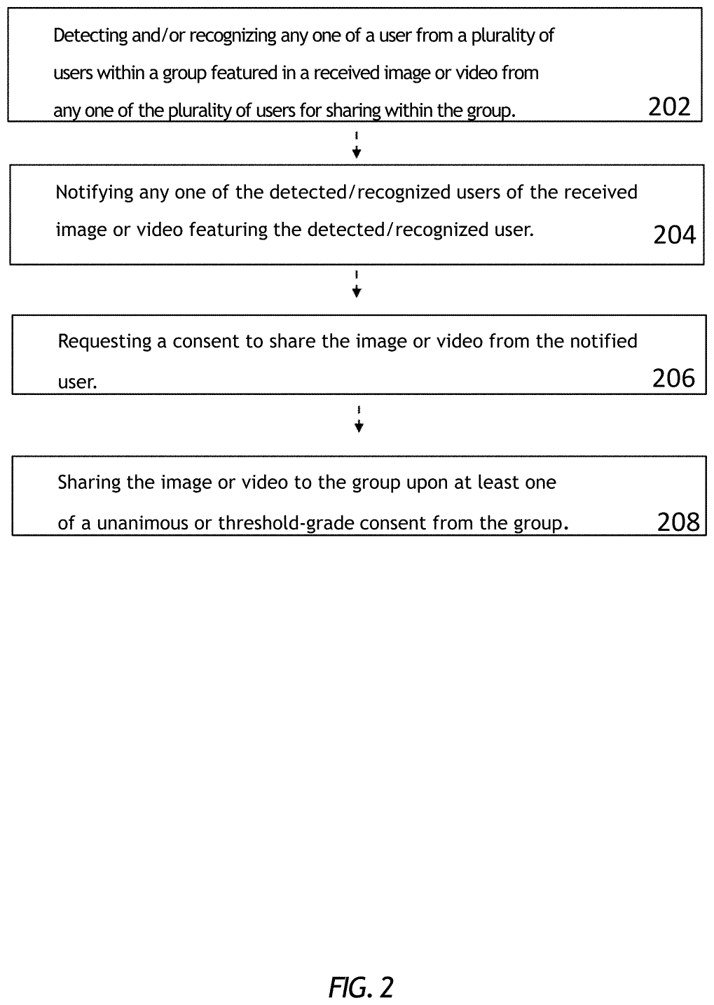

FIG. 2 depicts a method flow diagram in accordance with an aspect of the invention. As shown in FIG. 2, the method details the steps of: receiving an image or video from at least one user with a privilege to interact with a plurality of users within a group; detecting/recognizing any one of the plurality of users from the received image/video; notifying any one of the detected/recognized users from the received image/video; requesting a consent to share the image/video from the notified user; and sharing the image/video to the group upon at least one of an unanimous consent or a threshold-grade consent. While not shown in FIG. 2, the method of group-aware sharing may entail the steps of: receiving an image or video from at least one user of a plurality of users within a social network; detecting/recognizing any one of the plurality of users from the received image/video; notifying any one of the detected/recognized users from the received image/video; requesting a consent to share the image/video from the notified user; and sharing the image/video to the social network upon at least one of an unanimous consent or a threshold-grade consent.

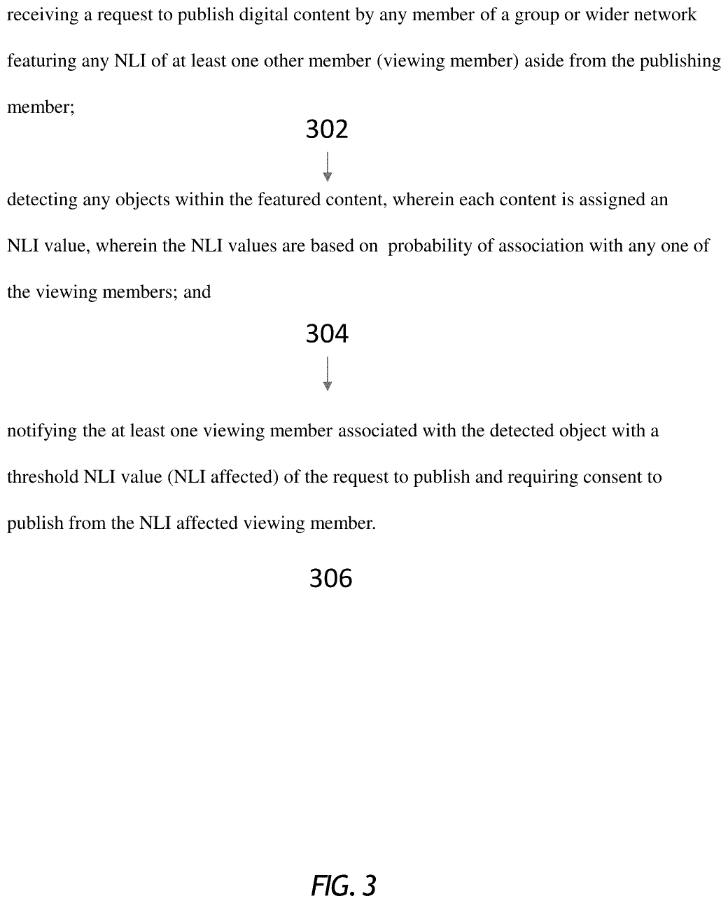

While FIG. 3 depicts a method flow diagram, illustrating the steps involved in digital NLI moderation (in accordance with an aspect of the invention), a system, with inter-related modules, as described above, is also contemplated for achieving the following steps: receiving a request to publish digital content by any member of a group or wider network featuring any NLI of at least one other member (viewing member) aside from the publishing member 302; detecting any objects within the featured content, wherein each content is assigned an NLI value, wherein the NLI values are based on probability of association with any one of the viewing members 304; and notifying the at least one viewing member associated with the detected object with a threshold NLI value (NLI affected) of the request to publish and requiring consent to publish from the NLI affected viewing member 306.

While not shown in FIG. 3, the digital content requested to be published may be in the form of an image, text, or video posted on a messaging application (dual or group chat) or social media application. Once received for posting or publication, the NLI moderation system may detect objects of interest—any object within a frame or series of frames that possess a threshold-grade NLI value. Objects detected within a frame/s may be subject to NLI valuation, wherein scores are based on a degree of association between the object and any of the viewing members in the group or network. Object scoring may be based on a machine-learnt or neural network-trained model with differentially weighed objects in a training set. For instance, a face-recognized object will have a higher NLI score due to its undeniable association with a viewing member, versus an unworn baseball cap of a viewing member due to the potential plausible deniability that a detached object may present—however unlikely.

In other embodiments, detached objects may be accorded higher NLI scores upon accounting for historical context of the suspected viewing member vis-à-vis the object. For instance, previously published content may feature viewing member A with the baseball cap and associate the stand-alone baseball cap in the frame with a high degree of confidence—and hence a higher NLI score. Historical context may be mined from data shared within the group or network, or may be crawled from ones digital or physical history/footprint/activity. The initial object (human face/body, articles of ownership) detection may be performed by any vision processing technique. In some embodiments, vision processing techniques may detect an object (using a machine-learning model, optionally) and bypass NLI valuation or scores directly prompting notification and consent requirement to the NLI-affected viewing member prior to publication by the publishing member.

In one embodiment, a text-based parsing technique may be employed to determine a text-based content to be detected as NLI-affecting and a notification/consent requirement being sent to the NLI-affected viewing member. In one embodiment, NLI scores may be ascribed to the text-based content based on a parsing for names or any other identifying text associated with a particular viewing member. Contextual data may be retrieved or crawled for to assign NLI value/scores to more ambiguous text. In some embodiments, text (or any other person/object in a video/image frame) may be detected as being associated with a member without assigning NLI values or scores. In yet other embodiments, NLI scores are generated and only activate downstream notification/consent requirement upon a pre-defined score threshold being reached.

For illustrative purposes, suppose a Ralph, in a messaging group with Dewayne and Mo, wished to post a picture of Mo—face-planted on the track just prior to the finishing line—to a shared folder or directly to the group. After intending to post, the request to post is sent in a form of a mobile-device notification to the publishing member (Ralph) and the NLI-affected member (Mo). While Ralph receives a notification pending consent from Mo, Mo receives a consent to publish notification. After being embarrassed from the unflattering depiction, Mo decides to deny publication, at which point Ralph will be notified of the denial and the image will be prevented from publishing. Mo's denial may flag the content for consent requirement moving forward, across other groups and, or networks—irrespective of Mo's membership in the group or network. In other embodiments, flagging may result in removal of the content from publishers device/server.

In certain instances, the NLI-affected member may wish to consent to publication, provided it is restricted or conditioned on at least one of member viewership, duration of publication, copy/storage limitations, transfer limitations, or post-processing editing. In continuing reference to the NLI-centric content being shared within Ralph's group, Mo may decide that the depiction isn't as unflattering as originally thought, and in fact, believes that another chat group, not involving Dewayne, may enjoy the picture, and as a result, decides to consent to publication with sharing privileges to only that select group.

In some embodiments, the publishing member may have the option to allow, deny, or counter the NLI-affected members publication/consent requirements. Once the limited sharing notification from Mo is sent to Ralph, Ralph may decide to deny Mo's request since Ralph's only intended recipient is Dewayne, whom Mo lost to in the race. As a result, Ralph's denial notification may be sent to Mo, whom may have the option to maintain his denial of consent to publish since he prefers Dewayne not get the satisfaction of memorializing Mo's agony of defeat and awkward fall. Any number of conditions and counter-offers may be possible prior to arriving at a final decision to publish or not. The off-group communication between members of the group creates interesting tributaries and branches from the main chat.

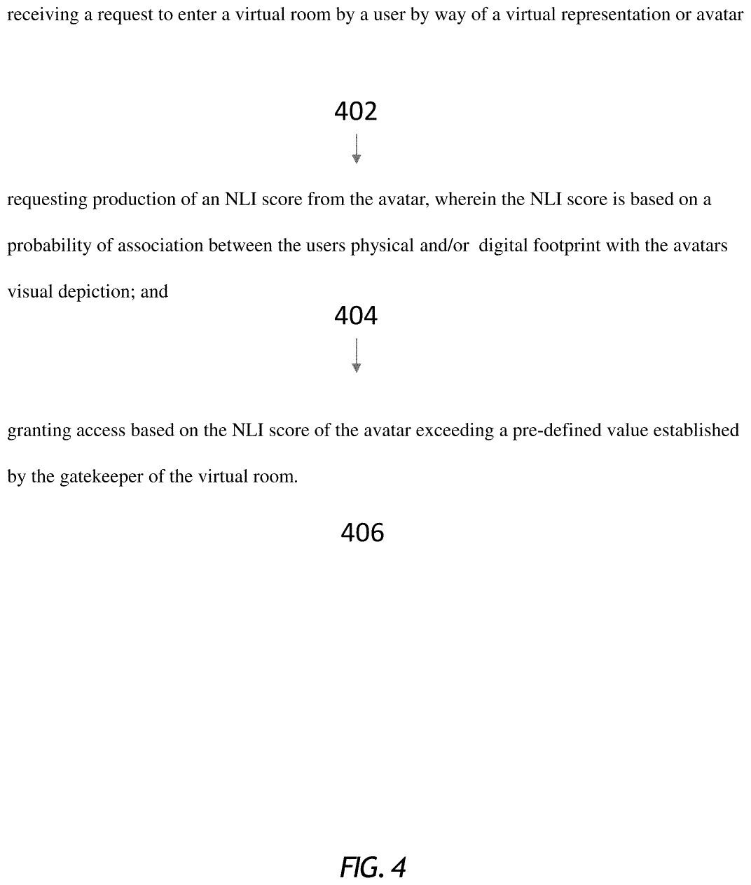

Now in reference to FIG. 4, which illustrates a method flow diagram, entailing the steps for rendering a footprint/activity-adjusted virtual representation or avatar, and, or deriving an NLI score for the avatar, wherein the score reflects a degree of association between the appearance of the avatar and an updated physical and, or digital footprint/activity. Given the pervasiveness of the virtual or augmented world in the near future, the use of avatars will be ubiquitous and will be the primary interface across virtual/mixed environments. To that end, avatars will be the primary drivers of our NLI, underscoring the need for accurately depicted avatars—one that dynamically adjusts and evolves visual elements to reflect a footprint in the virtual or physical world. Furthermore, NLI scores may be assigned to avatars to reflect the level of association between the members physical and, or virtual experiences. For instance, perhaps Mo has physically not achieved his step goals this past week due to being on vacation, and as result has gained a few pounds; now reflected in his avatar by adjusting the dimensions and other visual cues associated with weight gain, etc. Additionally, the vacationing may also inform the avatar adjustment by rendering the avatar with a tanned effect. However, while on vacation, Mo also happened to be very active on a New York Knicks internet chat group, sounding off on the teams owner for mismanagement, and therefore prompting Mo's avatar wearing a Patrick Ewing jersey. While also on vacation, Mo also happened to be introspective and cerebral and decided to stream the audio-book ‘Shantaram’ by Gregory David Roberts, while sitting poolside. However, the avatar rendered does not have any reference to this book and does not visually reflect this recent feat, and therefore would be assigned a low NLI score for failing to dynamically adjust to Mo's crawled/tracked digital or physical footprint. Low NLI scores are suggestive of an untrustworthy actor and may be denied entry into the virtual/mixed room. In some embodiments, gate-keepers may inquire further into any of the visual references of an avatar to receive more insights into the physical and, or digital footprint. Cursor or pointer control hovering over the reference may reveal these further insights.

FIG. 4 depicts a method for gatekeeping access into a virtual room: receiving a request to enter a virtual room by a user by way of virtual representation or avatar 402; requesting production of an NLI score from the avatar, wherein the NLI score is based on a probability of association between the users physical and/or digital footprint with the avatars visual depiction 404; and granting access based on the NLI score of the avatar exceeding a pre-defined value established by the gatekeeper of the virtual room 406.

Embodiments are described at least in part herein with reference to flowchart illustrations and/or block diagrams of methods, systems, and computer program products and data structures according to embodiments of the disclosure. It will be understood that each block of the illustrations, and combinations of blocks, can be implemented by computer program instructions. These computer program instructions may be provided to a processor of a general-purpose computer, special purpose computer, or other programmable data processing apparatus to produce a machine such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus, to produce a computer implemented

process such that, the instructions which execute on the computer or other programmable apparatus provide steps for implementing the functions/acts specified in the block or blocks.

In general, the word “module” as used herein, refers to logic embodied in hardware or firmware, or to a collection of software instructions, written in a programming language, such as, Java, C, etc. One or more software instructions in the unit may be embedded in firmware. The modules described herein may be implemented as either software and/or hardware modules and may be stored in any type of non-transitory computer-readable medium or other non-transitory storage elements. Some non-limiting examples of non-transitory computer-readable media include CDs, DVDs, BLU-RAY, flash memory, mobile device, remote device, and hard disk drives.

I/We claim:

1) A method for moderating a group or network members name, likeness, or image (NLI), said method comprising the steps of:
receiving a request to publish digital content by any member of a group or wider network featuring any NLI of at least one other member (viewing member) aside from the publishing member;
detecting any objects within the featured content, wherein each content is assigned an NLI value, wherein the NLI values are based on probability of association with any one of the viewing members; and
notifying the at least one viewing member associated with the detected object with a threshold NLI value (NLI affected) of the request to publish and requiring consent to publish from the NLI affected viewing member.

2) The method of claim 1, wherein the request to publish is in the form of posting an image, text, or video on a messaging application (dual or group chat) or social media application.

3) The method of claim 1, wherein the detection is by any object detection using a machine learning model.

4) The method of claim 1, wherein the detection is by any vision processing technique.

5) The method of claim 1, wherein the detection is any text-based parsing technique.

6) The method of claim 1, wherein the featured content further comprises inanimate objects detected with a threshold-grade NLI value.

7) The method of claim 6, wherein the inanimate objects have a depiction referencing any one of the members.

8) The method of claim 1, wherein the request in a form of a mobile-device notification is pending until the NLI-affected member affirmatively consents.

9) The method of claim 1, wherein the consent to publish is conditioned on at least one of member viewership, duration of publication, copy/storage limitations, transfer limitations, or post-processing editing defined by the NLI-affected member.

10) The method of claim 1, wherein the publication requirements defined by the NLI-affected member is sent to the publishing member in a form of a mobile-device notification.

11) The method of claim 10, wherein the publication requirement notification is allowed or denied by the publishing member.

12) A method for moderating a users name, likeness, or image (NLI), said method comprising the steps of:
receiving a request to publish digital content by any member of a group or wider network featuring any detected NLI of at least one other member (viewing member); and
notifying the at least one viewing member associated with the detected NLI (NLI-affected) of the request to publish and requiring consent to publish from the NLI-affected viewing member.

13) The method of claim 12, wherein the request to publish is in the form of posting an image, text, or video on a messaging application (dual or group chat) or social media application.

14) The method of claim 12, wherein the detection is by any object detection using a machine learning model.

15) The method of claim 12, wherein the detection is by any vision processing technique.

16) The method of claim 12, wherein the featured content further comprises inanimate objects detected with a threshold-grade NLI value.

17) The method of claim 16, wherein the inanimate objects have a depiction referencing any one of the members.

18) The method of claim 12, wherein the request in a form of a mobile-device notification is pending until the NLI-affected member affirmatively consents.

19) The method of claim 12, wherein the consent to publish is conditioned on at least one of member viewership, duration of publication, copy/storage/limitations, transfer limitations, or post-processing editing defined by the NLI-affected member.

20) The method of claim 12, wherein the publication requirements defined by the NLI-affected member is sent to the publishing member in a form of a mobile-device notification.

21) A method for gatekeeping access into a virtual room:
receiving a request to enter a virtual room by a user by way of virtual representation or avatar;
requesting production of an NLI score from the avatar, wherein the NLI score is based on a probability of association between the users physical and/or digital footprint with the avatars visual depiction; and
granting access based on the NLI score of the avatar exceeding a pre-defined value established by the gatekeeper of the virtual room.
